(19) United States
(12) Patent Application Publication
(10) Pub. No.: US 2004/0120507 A1
(43) Pub. Date: Jun. 24, 2004

(54) Ring signal voltage offset for subscriber line interface circuit

(76) Inventor: Nasser Pooladian, Roseville, MN (US)

Correspondence Address: SHUMAKER & SIEFFERT, P. A., 8425 SEASONS PARKWAY, SUITE 105, ST. PAUL, MN, 55125, US

(21) Appl. No.: 10/322,830

(22) Filed: Dec. 18, 2002

(51) Int. Cl. H04M 1/00; H04M 9/00

(52) U.S. Cl. 379/387.01

(57) ABSTRACT

Techniques are described for providing telephony devices with a ring signal that has a voltage offset. For example, a ring signal shifter may receive a ring signal and a tip signal from a source. The ring signal shifter may, for example, receive a ring signal and a tip signal that are identical except for a 180-degree phase difference during the ringing state, i.e., the ring and tip signals are balanced signals. The ring signal shifter may include circuitry that rectifies the tip signal and superimposes the tip signal onto the ring signal in order to obtain a ring signal shifted by an offset voltage. The shifted ring signal may be output to a telephony device that requires an offset voltage in order to operate properly. For example, the shifted ring signal may be output to an answering machine that require a ring signal with an offset in order to respond to calls.

### TECHNICAL FIELD

The invention relates to telephony devices and, more particularly, to ring and tip signals used to control ringing of telephony devices.

### BACKGROUND

Telephone circuits generally include a set of lines that interconnect telephony equipment of a customer with telephony equipment at a central office. For example, a ring line and a tip line may interconnect a telephone with the central office. When the customer lifts the handset of the telephone, current (about 25 milliamps) flows from a central office power supply through the telephone and back to the central office via the ring and tip lines.

When the central office receives a call for the customer telephone, the central office makes the telephone ring by sending stream of pulses between the ring and tip lines. Standard analog ringing signals include an AC ringing signal with a negative DC voltage offset. The ringing signal may be, for example, approximately 250 volts in peak-to-peak amplitude with a −50 volt DC offset as measured on the ring line with respect to the tip line. A ringer within the telephone is built so that it will not pass any DC current when it is connected to a telephone line. In this manner, only the AC ring signal can cause the ringer to ring.

A subscriber line interface circuit (SLIC) or other digital loop carrier interface may provide balanced ringing signals as opposed to the AC ringing signals described above. During balanced ringing, the ring line and the tip line are driven by identical signals that are 180-degrees out of phase. For instance, the ring line and the tip line may be driven by 20-Hertz (Hz) trapezoidal waveforms that are 180-degrees out of phase. Unlike the conventional analog signals, the ring signal in a balanced ringing scheme does not have a negative DC offset voltage on the ring line.

### SUMMARY

In general, the invention is directed to techniques for providing telephony devices with a ring signal that has a voltage offset. More particularly, the techniques include receiving a ring signal from a source, shifting the ring signal by an offset voltage, and outputting the ring signal to a telephony device that requires the offset voltage for proper operation.

Certain telephony equipment, such as some telephones, answering machines, and fax machines, require the negative DC voltage offset of standard analog ringing for proper operation. The lack of the negative DC voltage offset provided in the balanced ringing scheme generated by the subscriber line interface circuit (SLIC) chips can cause improper operation of the telephony equipment that requires this negative DC voltage shift.

For example, an answering machine that requires the negative DC voltage offset for proper operation will not respond to an incoming call when connected to an SLIC that produces a balanced ringing signal. Some SLICs may impose a negative DC voltage shift on the ring line during ringing, but the negative DC voltage shift will have undesired effects, such as reducing the total root means square (RMS) voltage of the ringing signal. The reduction of the total RMS voltage of the ringing signal will reduce the amount of power delivered to the load, i.e., the telephony equipment.

A ring signal shifter, in accordance with the invention, may receive a ring signal and a tip signal from a source. The ring signal shifter may, for example, receive a ring signal and a tip signal that are identical except for a 180-degree phase difference, i.e., the ring and tip signals are balanced signals. The ring signal shifter may include circuitry that rectifies the tip signal and superimposes the tip signal onto the ring signal in order to obtain a ring signal shifted by an offset voltage. The ring signal shifter may, for example, shift the received ring signal by approximately −50 volts in order to emulate conventional analog ring signals. The shifted ring signal may be output to a telephony device that requires an offset voltage in order to operate properly. For example, the shifted ring signal may be output to an answering machine that requires a ring signal with an offset in order to respond to calls.

In one embodiment, the invention provides a telephony device comprising a first ring line to receive a ring signal from a source, a voltage shift circuit to shift the ring signal from the source by an offset voltage, and a second ring line to output the shifted ring signal to a client telephony device.

In another embodiment, the invention provides a method comprising receiving a ring signal on a ring line, shifting the ring signal by an offset voltage, and providing the shifted ring signal to a client telephony device.

In a further embodiment, the invention provides a telephony device comprising means for receiving a ring signal from a source, means for shifting the ring signal from the source by an offset voltage, and means for outputting the shifted ring signal to a client telephony device.

The invention can provide a number of advantages. In general, the invention can enable a ring signal to be shifted by an offset voltage without reducing the RMS voltage of the ring signal. In this manner, the invention preserves the power delivered to the ringer in order to help prevent loss of ring initiation or reduction in ring strength (loudness). Further, the ring signal shifter may be an independent device that can be electrically coupled between a telephony device and a source, enabling the ring signal to be shifted without intervention in the current communication system. The ring signal shifter also may manage to shift the ring signal without interfering with the communication loop or voice channel. The invention further supports compatibility of “legacy” telephony equipment, i.e., telephony equipment that requires the negative DC voltage offset for proper operation, with new SLIC equipment. This compatibility broadens the range of equipment with which the new SLIC equipment is compatible with while avoiding the need to upgrade old equipment.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a telephony ringing system that shifts a ring signal by an offset voltage.

FIG. 2 is a block diagram illustrating an exemplary passive optical network (PON) in which one or more ring signal shifters can be used to provide a ring signal with an offset voltage to telephony devices.

FIG. 3 is a block diagram illustrating a client side of the PON of FIG. 2 in further detail.

FIG. 4 is a block diagram of an exemplary voltage shift circuit for use within a ring signal shifter.

FIG. 5 is a graph illustrating exemplary plots of ring and tip signals received by ring signal shifter and output from ring signal shifter.

FIG. 6 is a block diagram illustrating a plan view of circuit elements arranged to form a voltage shift circuit of a ring signal shifter.

FIG. 7 is a flow diagram illustrating a technique for shifting a ring signal by an offset voltage.

### DETAILED DESCRIPTION

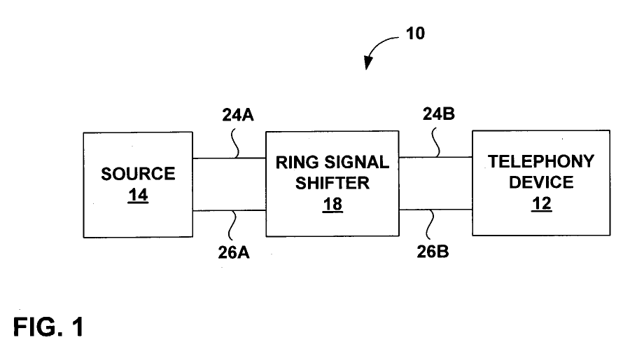

FIG. 1 is a block diagram illustrating a telephony ringing system 10 that shifts a ring signal by an offset voltage in accordance with the invention. Ringing system 10 includes a telephony device 12 that connects to a source 14 through a ring signal shifter 18. More specifically, the connection between source 14 and telephony device 12 forms a communication loop that extends from source 14 through ring signal shifter 18 to telephony device 12 and back to source 14 through ring signal shifter 18.

Ring signal shifter 18 is electrically connected to source 14 via a ring line 24A and a tip line 26A. Ring signal shifter 18 may, for example, be electrically connected to source 14 via standard Plain Old Telephone Service (POTS) lines that includes ring line 24A and tip line 26A. Ring signal shifter 18 is also electrically connected to telephony device 12 through a ring line 24B and a tip line 26B.

Source 14 provides ringing for telephony device 12. More specifically, source 14 drives ring line 24A and tip line 26A with a ring signal and a tip signal, respectively. Source 14 may drive ring line 24A and tip line 26A with various ringing methods such as unbalanced ringing and balanced ringing. During unbalanced ringing, source 14 applies a ring signal to ring line 24A and tip line 26A is connected to ground. For example, when source 14 applies a ring signal to ring line 24, a voltage of the ring signal swings between approximately 0V and a high potential, which may be approximately −90V.

During balanced ringing, source 14 outputs two identical signals that are 180-degrees out of phase. One of the signals drives ring line 24A. The other signal, i.e., the signal with the 180-degree phase difference, drives tip line 26A. For instance, source 14 may output a pair of 20-Hertz (Hz) trapezoid wave signals that are 180-degrees out of phase to drive ring line 24A and tip line 26A. Unlike the conventional analog ring signals, however, the signals used in balanced ringing and unbalanced ringing do not have a negative DC offset voltage. Again, this difference may result in inoperability of some types of telephony equipment that are designed to operate with a negative DC voltage offset.

Source 14 may include a digital loop carrier interface, such as a subscriber line interface circuit (SLIC). The SLIC may reside within a node of a passive optical network (PON), a central office of a telephone service provider, a private branch exchange (PBX) system, a tap of a hybrid fiber/coax (HFC) system, or the like. For example, the SLIC may reside within a node of a PON and provide an interface between telephony device 12 and source 14. The SLIC may, for example, perform analog to digital (A/D) and digital to analog (D/A) conversions on information to and from telephony device 12. The SLIC may also generate ring and tip signals for telephony device 12 using one of the ringing methods described above. The SLIC may, for example, operate in a balanced ringing mode to output balanced ring and tip signals to telephony device 12.

Telephony device 12 may include an answering machine, a fax machine, a telephone, and the like. Telephony device 12 may require a negative DC offset voltage, such as the negative DC offset voltage of conventional analog ring signals, in order to operate properly. For example, telephony device 12 may include an answering machine that does not respond to an incoming call when the ring signal is not offset by the negative DC offset voltage. Accordingly, the invention contemplates techniques for accommodating incompatibility of certain telephony devices 12 with the balanced and unbalanced ringing techniques employed in SLICs. In this manner, the invention broadens the range of telephony equipment compatible the new SLIC equipment while avoiding the need to upgrade legacy telephony equipment.

Ring voltage shifter 18 shifts a ring signal from source 14 by an offset voltage. Ring voltage shifter 18 receives, for example, a ring signal and a tip signal from source 14. In the case of balanced ringing, source 14 drives ring line 24A and tip line 26A with identical signals that have a 180-degree phase difference. In one embodiment, ring voltage shifter 18 rectifies the tip signal driving tip line 26A and superimposes the rectified tip signal onto the ring, signal on ring line 24B, in turn, shifting the ring signal by an offset voltage. The shifted ring signal provided by ring voltage shifter 18 allows telephony device 12 to operate properly, e.g., respond to incoming calls.

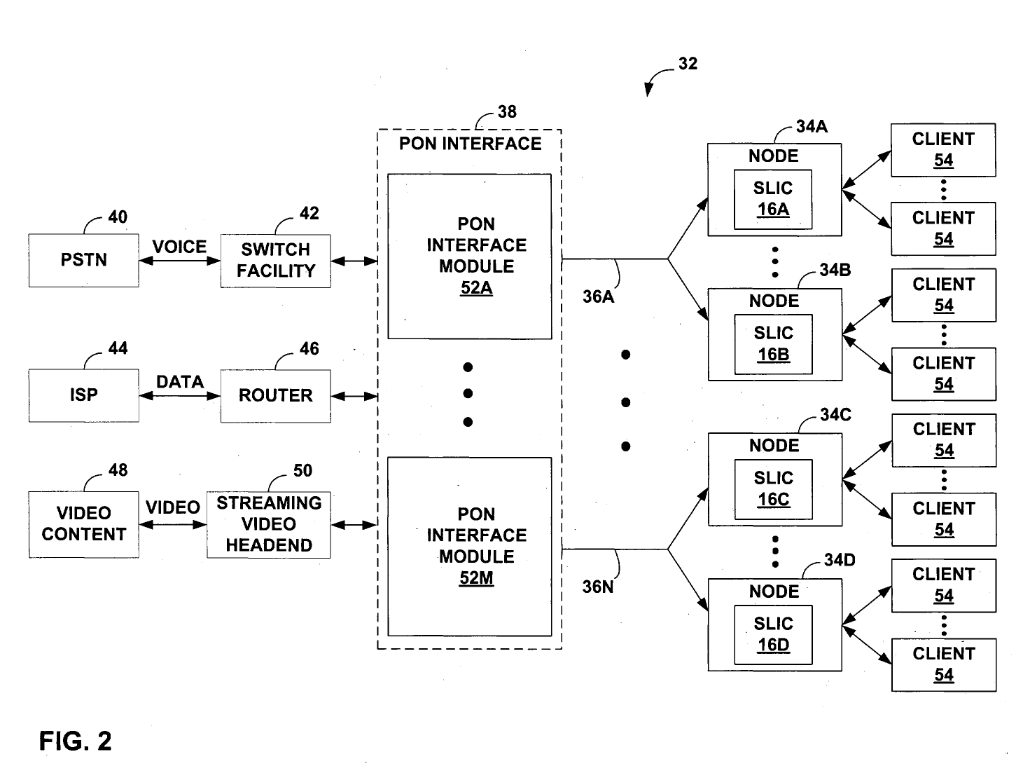

FIG. 2 is a block diagram illustrating an exemplary passive optical network (PON) 32 in which one or more ring signal shifters 18 can be used to provide a ring signal with an offset voltage to telephony devices 12. PON 32 is described for purposes of illustration and should not limit the invention as broadly embodied herein. Various other systems may use ring signal shifter 18 to shift a ring signal by an offset voltage, including hybrid fiber/coax (HFC) systems or other systems that provide networked packages of video, voice, and data. Further, ring signal shifter 18 may be used in conjunction with private exchange branch (PBX) equipment, Telephone Information Management System (TIMS) equipment, and other telephone equipment.

As shown in FIG. 2, PON 32 is arranged to deliver voice, data, and video content (generally “information”) to a number of network nodes 34A-34D (“network nodes 34”) via optical fiber links 36A-36N (“optical fiber links 36”). Exemplary components for implementing PON 32 are commercially available from Optical Solutions, Inc., of Minneapolis, Minn., and designated by the trade name Fiberpath 40O^{TM}, including the Fiberdrive^{Tm} headend bay interface and the Fiberpoint^{TM} subscriber premise nodes.

PON 32 includes a PON interface 38 that receives information and distributes the information along optical fiber links 36 to groups of network nodes 34. For example, PON interface 38 may receive voice information from a public switched telephone network (PSTN) 40 via a switch facility 42. In addition, PON interface 38 may be coupled to one or more Internet service providers (ISPs) 44 via a router 46 and the Intenet. As further shown in FIG. 1, PON interface 38 may receive video content 48 from video content suppliers via a streaming video headend 50.

In each case, PON interface 38 distributes the information along optical fiber links 36 to groups of network nodes 34. A group of network nodes 34 may refer to nodes 34 served by PON interface 38 and, more particularly, served by a corresponding one of PON interface modules 52A-52M (“PON interface modules 52”) within PON interface 38 via a common optical fiber link 36. A group of network nodes 34 may include a single network node 34, or numerous network nodes 34.

Each PON interface module 52, sometimes referred to as a line card, is coupled to a group of network nodes 34 via an optical fiber link 36. PON interface 38 may include multiple PON interface modules 52, e.g., arranged in a common chassis. Each PON interface module 52 may form an independent Ethernet interface that serves the group of network nodes 34 coupled by the common optical fiber link 36. Hence, PON interface modules 52 and nodes 34 terminate opposite ends of optical fiber links 36.

Network nodes 34, sometimes referred to as optical network terminators (ONTs) or optical network units (ONUs), may include hardware for receiving information from PON 32 via optical fiber links 36, and delivering the information to one or more clients 54 associated with node 34. For example, each network node 34 may serve as a PON access point for one or more clients 54. Network nodes 34 also may include hardware for transmitting information from the associated clients 54 over PON 32. For example, a network node 34 may transmit voice information over PSTN 40 via PON interface 38 and switch facility 42 in the course of a telephone conversation. In this manner, network nodes 34 may act as an interface between PON 32 and clients 54. Clients 54 may include telephony devices such as telephones, fax machines, answering machines, and the like. Further, clients 54 may include other devices such as computers, network appliances, televisions, set-top boxes, wireless devices, and the like.

The hardware within network nodes 34 for receiving information from PON 32 and delivering the information to clients 54 and transmitting information from the clients 54 over PON 32 may, for example, reside within a corresponding one of SLICs 16A-16D (“SLICs 16”). Network node 34 and, more particularly SLIC 16 may act as an interface to allow information to flow from the optical fiber framework of PON 32 to an electrical metallic framework, such as a ring and tip line, a copper wire, or coaxial cable client network. For instance, SLIC 16 may provide an interface for the two frameworks by performing an opto-electrical conversion on information from PON interface modules 52 to clients 54. SLIC 16 may also act as an interface for information transmitted in the opposite direction, i.e. from an electrical metallic framework to an optical fiber framework.

PON 32 may further include one or more ring signal shifters 18 (not shown). As described herein, ring signal shifters 18 receive a ring signal and a tip signal, and shift the ring signal by an offset voltage to permit compatibility of particular telephony equipment with the ring scheme employed by SLIC 16. Ring signal shifters may, for example, receive balanced ring and tip signals, rectify the balanced tip signal, and superimpose the rectified tip signal onto the ring signal of the ring line to client 54 in order to obtain a ring signal with a negative voltage offset. Ring signal shifters 18 may reside within network nodes 34. Alternatively, ring signal shifters 18 may be separate devices that interconnect network nodes 34 with respective clients 54.

In some embodiments, optical fiber link 36 may include a pair of optical fibers, forming an outgoing link and an incoming link. For example, the outgoing fiber optical link may transmit information from PON interface 38 to network nodes 34. The incoming fiber optical link may transmit information from network nodes 34 to PON interface 38.

PON interface 38 may be located near or far from a group of network nodes 34. In some existing networks, however, PON interface 38 may reside in a central office situated within approximately ten miles from each network node 34. A network node 34 may be located at any of a variety of locations, including residential or business sites. In addition, a single network node 34 may operate on a shared basis to deliver information to clients within two or more closely located residences or businesses via copper or additional optical fiber connections, either directly or via a network hub, router or switch.

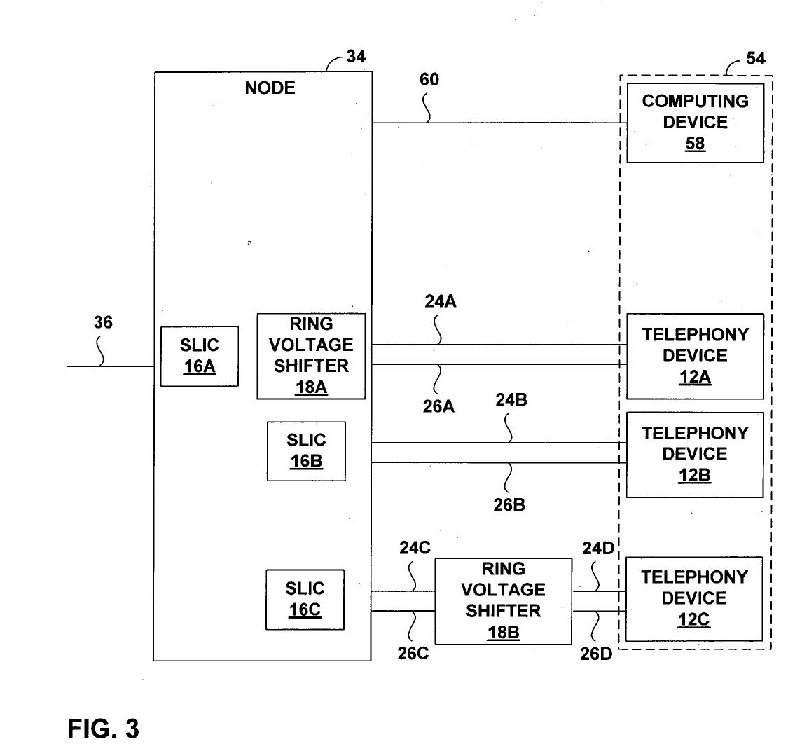

FIG. 3 is a block diagram illustrating a client side of passive optical network 32 in further detail. A network node 34 acts as an interface between PON 32 (not shown in FIG. 3) and clients 54. More particularly, network node 34 receives information from PON 32 via an optical fiber link 36, and delivers the information to one or more clients 54 associated with node 34. Network node 34 also may transmit information from clients 54 over PON 32. For example, a network node 34 may transmit voice information over PSTN 40 via PON interface 38 and switch facility 42 in the course of a telephone conversation.

As described above, node 34 may interface between PON 32 and a variety of different clients 54. In the example of FIG. 3, node 34 acts as an interface between PON 32 and a client device 58 and between PON 32 and telephony devices 12A-12C (“telephony devices 12”). Although node 34 may act as an interface between PON 32 and any number of clients 54, for simplicity, the example of FIG. 3 illustrates node 34 acting as an interface between clients 54 and PON 32.

Network node 34 couples to client device 58 via a cable 60. Cable 60 may be another optical fiber link, a copper wire, a coaxial cable, an Ethernet link, or the like. Client device 58 may include devices such as computers, network appliances, televisions, set-top boxes, wireless devices, and the like.

Network node 34 further couples to telephony devices 12 via corresponding ring lines 24A-24D (“ring lines 24”) and tip lines 26A-26D (“tip lines 26”). Each of telephony devices 12 may correspond with one of SLICs 16A-16C (“SLICs 16”). As described above, SLICs 16 may perform A/D and D/A conversions, opto-electrical conversions, and the like. Further, SLICs 16 may generate ring and tip signals for telephony devices 12 using various ringing methods. More particularly, SLICs 16 may receive a signal indicating the need to ring a particular telephony device 12. SLIC 16 generates ring and tip signals, e.g., via a balanced ringing method, in response to the optical signal and drives a corresponding ring line 24 and tip line 26 with the ring and tip signals, respectively.

A ring signal shifter 18 may interconnect one of SLICs 16 and one of telephony devices 12 that require a ring signal with a voltage offset for proper operation. Ring signal shifter 18 may reside within node 34 as illustrated by ring signal shifter 18A. Alternatively, ring signal shifter 18 may be a separate device that interconnects one of SLICs 16 and one of telephony devices 12 as illustrated by ring signal shifter 18B. Ring signal shifter 18B electrically couples to node 34 and, more particularly, to SLIC 16C via ring line 24C and tip line 26C. Ring signal shifter 18B further electrically couples to telephony device 12 via ring line 24D and tip line 26D.

During balanced ringing, ring signal shifter 18B receives balanced ring and tip signals from SLIC 16C within node 34. Specifically, the ring signal driving ring line 24C is identical to the tip signal driving ring line 26C with a 180-degree phase difference. A circuit within ring signal shifter 18B rectifies the tip signal received on tip line 26C and superimposes the rectified tip signal onto the ring signal of ring line 24D. In this manner, the ring signal output by ring line 24D is identical to the ring signal received on ring line 24C with a negative voltage offset. The negative voltage offset of the ring signal output by ring line 24D produces substantially the same ring effect as a conventional analog signal. The signal output on tip line 26D is identical to the tip signal received on tip line 26C. In this manner, ring signal shifters 18 shift the ring signal output to respective telephony devices 12 to ensure proper operation. Since ring signal shifter 18 may be a separate device that electrically couples between telephony devices 12 and SLICs 16, ring signal shifter 18 may shift the ring signal without intervention with the current communication system. Further, when the ring signal shifter 18 resides within node 34, the ring signal may be shifted by an offset voltage without reducing the root mean square (RMS) voltage of the ring signal. In this manner, the invention preserves the power delivered to telephony device 12C while providing the offset voltage to ring line 24C. Preserving the power delivered to telephony device 12C may be crucial in helping to prevent ringer initiation loss or loss in ringer strength (loudness).

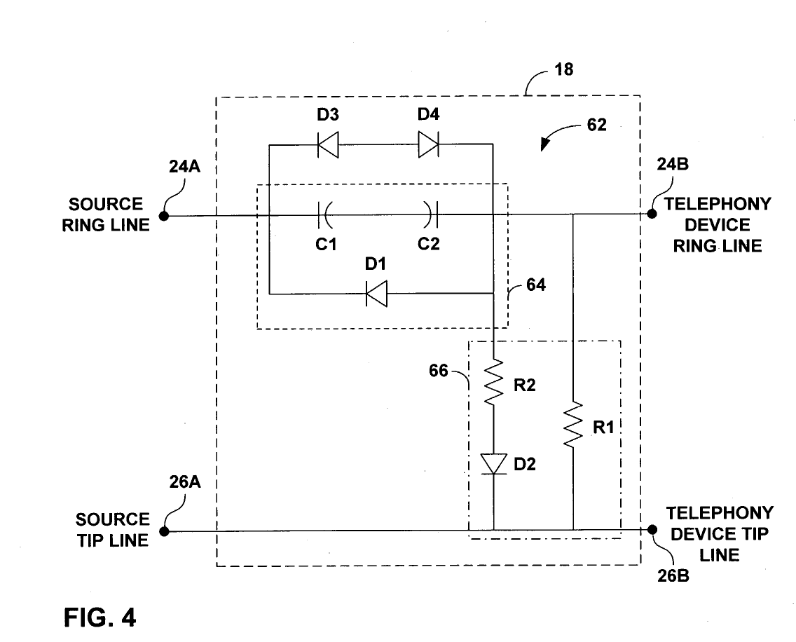

FIG. 4 is a block diagram of an exemplary voltage shift circuit 62 that may be found within ring signal shifter 18. Voltage shift circuit 62 includes capacitors C1 and C2, diodes D1-D4, and resistors R1 and R2. More particularly, a first circuit block 64 includes diode D1 connected in parallel with polarized capacitors C1 and C2, which are connected in series with opposite polarities to realize a larger capacitance while reducing the amount of area needed. Although illustrated in FIG. 4 as two separate capacitors C1 and C2, in other embodiments capacitors C1 and C2 may be realized by a single larger capacitor. Circuit block 64 further includes diodes D3 and D4 connected in series with one another and connected in parallel with diode D1 and capacitors C1 and C2. Diodes D3 and D4 protect capacitors C1 and C2 from excessive voltages such as ESD from undesired sources. For example, diodes D3 and D4 may protect capacitors C1 and C2 from excessive voltages due to lightning strikes. A second circuit block 66 includes resistor R1 connected in parallel with resistor R2 and diode D2, which are connected in series. Circuit blocks 64 and 66 are connected in series to form voltage shift circuit 62.

In general, voltage shift circuit 62 shifts a received ring signal by an offset voltage while maintaining proper operation of on-hook and off-hook states. The functioning of voltage circuit 62 will be described in terms of three states; (1) the on-hook state, (2) the off-hook state, and (3) the ringing state.

When voltage shift circuit 62 is operating in the on-hook state, tip line 26A stays near zero volts while ring line 24A stays at approximately -50 volts DC with respect to ground and tip line 26A. Tip line 26B, i.e., the tip line on the telephony device side, stays at the same potential as tip line 26A. Because the potential of tip line 26A and 26B is greater than the potential of ring line 24A, diode D1 is normally forward biased. A forward biasing diode D1 results in ring line 24B, i.e., the ring line of the telephony device side, having a potential that is a diode drop (approximately 0.3-0.7 volts) more than the potential of ring line 24A, i.e., approximately −49.3-−49.7 volts. Forward biased diode D1 shorts capacitors C1 and C2, which serve to block the DC components of the ring signals. Diode D2 is reverse biased due to the fact that the potential of tip line 26A and 26B is greater than the potential of ring line 24A and ring line 24B. In this manner, a communication loop is established from tip line 26A to ring line 24A and voice or data communications are possible during the on-hook state. More particularly, the communication loop follows tip line 26A and 26B, through resistor R2 and telephony device 12, through diode D1, and out ring line 24A.

When voltage shift circuit 62 is operating in the off-hook state, a communication loop is established from tip line 26A to ring line 24A. Similar to the on-hook state, diode D1 is forward biased to allow current to flow from tip line 26A to ring line 24A. Capacitor C1 and C2 are short circuited by diode D1. Diode D2 is reverse biased since the potential at tip line 26A is closer to zero than the potential at ring line 24A. A DC current path goes through the telephony device and resistor R1. The DC current through R1 is a minimal amount (usually less than 1%) of the total DC current. Since resistor R1 is much larger than the resistance of most telephony devices 12 (which have a resistance of approximately 600 Ohms), resistor R1 affects the load impedance by only a small percentage.

When voltage shift circuit 62 is operating in the ringing state, ring line 24A and tip line 26A are driven by tip and ring signals. For instance, ring line 24A and tip line 26A may be forced to negative high potential alternately at a particular rate. Particularly, when the potential on ring line 24A is at a peak negative high battery, tip line 26A is at approximately ground potential. Further, when the potential on tip line 26A is at a peak negative high battery, ring line 24A is at approximately ground potential. Alternately forcing ring line 24A and tip line 26A to negative high battery emulates balanced ringing.

During the ringing state capacitors C1 and C2 block the DC component and conduct the AC component of the ring signal driving ring line 24A onto ring line 24B. The tip line 26A is coupled to ring line 24B through resistor R2 and to tip line 26B. Diode D2 rectifies the tip signal on tip line 26A. More particularly, diode D2 conducts when the potential of ring line 24B is higher than the potential of tip line 26B resulting in a rectification of the tip signal. The rectified tip signal is superimposed on the ring line 24B the AC component of the ring signal conducted to ring line 24B. Resistor R1 limits the amount of current running through diode D2, in turn, controlling the DC voltage potential on ring line 24B. For example, to maintain −50 volts DC across resistor R1, there must be approximately 1.5 milliamps of current. The current may be provided in the start of the ringing through diode D2 and maintained by capacitors C1 and C2. Diode D1 is reverse biased due to the distribution of the potential on ring line 24B. In particular, diode D1 is reverse biased during the ringing state because the potential of the shifted ring signal on ring line 24B is always less negative than the potential of the ring signal on ring line 24A. During the ringing mode, there is no DC current circulation from tip line 26A to ring line 24A, i.e., no communication loop is established. In this manner, ring signal shifter 18 shifts the ring signal without interfering with the communication loops established during on-hook and off-hook states.

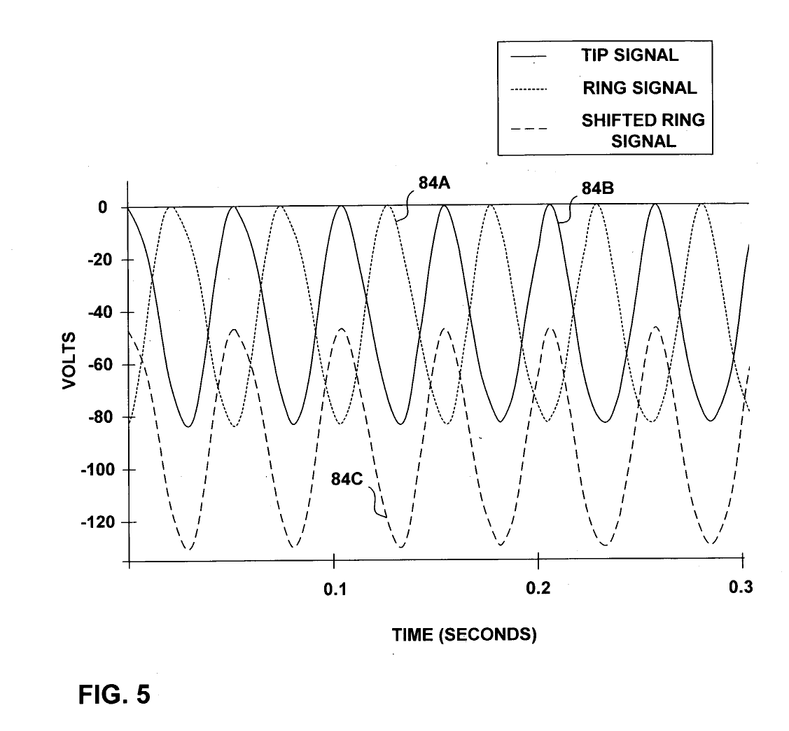

FIG. 5 is a graph illustrating exemplary plots of ring and tip signals received to ring signal shifter 18 and output from ring signal shifter 18. In the plots of FIG. 5, line 84A represents tip signals received on tip line 26A and output on tip line 26B. Line 84B represents a ring signal received on ring line 24A. As illustrated in the graph, lines 84A and 84B represent received tip signals and ring signals, respectively, and are identical with a phase difference of 180-degrees. This is due to the fact that the tip and ring signals received by ring signal shifter 18 are balanced signals.

Line 84C represents the ring signal output on ring line 24B. As discussed above, ring signal shifter 18 rectifies the tip signal received on tip line 26A and superimposes the rectified tip signal on the ring signal of ring line 24B. As illustrated in the graph, line 84C and 84B are identical plots with a negative voltage offset of approximately −50 volts. The voltage offset of −50 volts may be necessary for proper operation of certain telephony devices 12.

Although the plots illustrated in FIG. 5 are sinusoids, ring signal shifter 18 may receive ring and tip signals with other shapes. For instance, ring signal shifter may receive ring and tip signals that are triangular waves, square waves, trapezoid waves, or the like. No matter the shape of the ring and tip signals, ring signal shifter shifts the ring signal by an offset voltage.

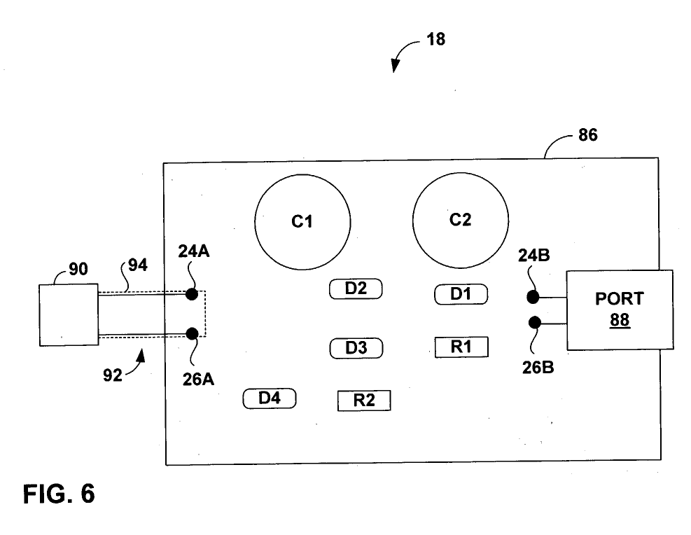

FIG. 6 is a block diagram illustrating a plan view of circuit elements arranged to form voltage shift circuit 62 of ring signal shifter 18. The plan view of FIG. 6 illustrates the arrangement of circuit elements including resistors R1 and R2, capacitors C1 and C2, and diodes D1-D4 on a circuit board 86. The circuit elements are electrically coupled to one another to form circuit 62 of FIG. 4. The circuit elements may be electrically coupled using strip lines, microstrips, wires and soldering, and the like.

Ring signal shifter 18 further includes a connector 90 and a port 88 for electrically coupling ring signal shifter 18 to a source 14 and a telephony device 12, respectively. Connector 90 may, for example, electrically couple ring signal shifter 18 to source 14. More specifically, connector 90 may bridge a connector that extends from a phone line. Connector 90 may, for example, be a Registered Jack-11 (RJ-11) connector that extends between ring signal shifter 18 and source 14. More specifically, connector 90 electrically couples ring line 24A and tip line 26A to ring and tip lines of source 14.

Connector 90 is coupled to an extension 92 that extends from ring signal shifter 18. Extension 92 includes a ring line 24A and a tip line 26A enclosed by a sheath 94. Sheath 94 may be constructed of plastic or other suitable material. Sheath 94 prevents damage to ring line 24A and tip line 26A. Extension 92 may further include lines other than ring line 24A and tip line 26A. For example, a typical RJ-11 connector may have up to four, and sometimes six, lines or wires.

Port 88 electrically couples ring signal shifter 18 to a telephony device 12, such as an answering machine, a fax machine, or a telephone. Port 88 accepts a connector that extends between telephony device 12 and ring signal shifter 18. Upon accepting the connector, port 88 electrically couples ring line 24B and tip line 26B to ring and tip lines of telephony device 12.

FIG. 6 depicts ring signal shifter 18 as electrically coupled to source 14 via connector 90 and to telephony device 12 via a port 88. However, ring signal shifter 18 may electrically couple to source 14 and telephony device 12 via any combination of the ports and connectors. For example, ring signal shifter 18 may connect to both source 14 and telephony device 12 via connectors 90.

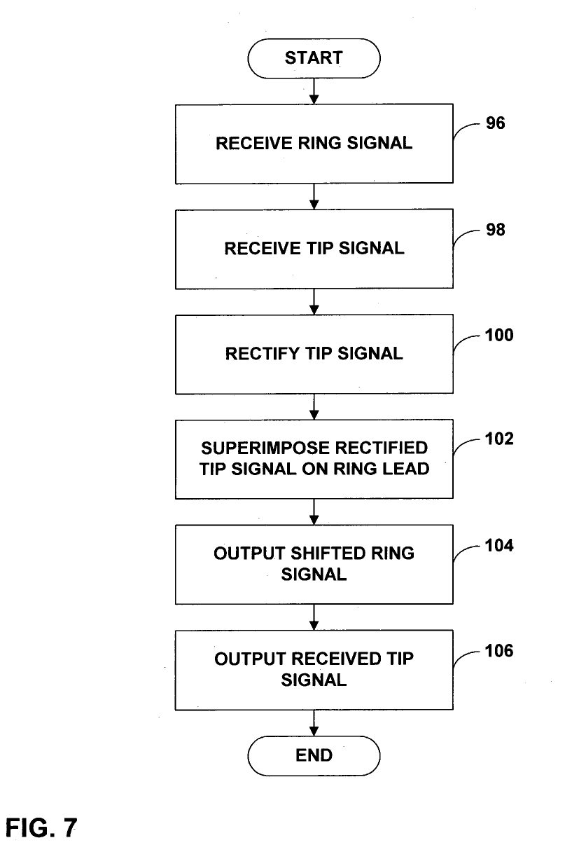

FIG. 7 is a flow diagram illustrating a technique for shifting a ring signal by an offset voltage. A ring signal shifter 18 receives a ring signal and a tip signal from a source 14 (96, 98). The ring signal and the tip signal may be identical signals that have a 180-degree phase difference, i.e., balanced signals. The ring signal and tip signal may be sinusoid waves, triangular waves, square waves, trapezoid waves, or any of a number of wave shapes. Ring signal shifter 18 may, for example, receive the ring and tip signals from an SLIC 16 within a node 34 of a PON 32, as in FIG. 2.

Ring signal shifter 18 rectifies the tip signal (100). Ring signal shifter may, for example, rectify the tip signal using resistors, capacitors, and diodes arranged as shown in ring voltage shift circuit 62 of FIG. 4. More specifically, diode D2 conducts when the potential of ring line 24B is higher than the potential of tip line 26B resulting in a rectification of the tip signal. The rectified tip signal is superimposed on the ring line 24B along with the AC component of the ring signal conducted to ring line 24B (102). The ring signal on ring lead 24B may be identical to the ring signal on ring lead 24A with an offset voltage shift. Circuit elements of ring voltage shift circuit 62 may be selected in order to realize an offset voltage shift of approximately −50 volts in order to simulate conventional analog ring signals.

Ring signal shifter 18 outputs the shifted ring signal and the tip signal to a telephony device 12 via ring line 24B and tip line 26B, respectively (104, 106). The tip signal output on tip line 26B is identical to the tip signal received on tip line 26A. The shifted ring signal output on ring line 24B provides telephony device 12 with a ring signal that has an offset voltage used by telephony device 12 for proper operation.

Various embodiments of the invention have been described. These and other embodiments are within the scope of the following claims.

1. A telephony device comprising:
a first ring line to receive a ring signal from a source;
a voltage shift circuit to shift the ring signal from the source by an offset voltage; and
a second ring line to output the shifted ring signal to a client telephony device.

2. The device of claim 1, further comprising:
a first tip line to receive a tip signal from the source; and
a second tip line to output the tip signal to the client telephony device.

3. The device of claim 2, wherein the voltage shift circuit rectifies the tip signal from the source and superimposes the rectified tip signal onto the ring signal to shift the ring signal by an offset voltage.

4. The device of claim 2, wherein the voltage shift circuit includes:
a first circuit block in which a capacitor and a first diode are connected in parallel; and
a second circuit block in which a first resistor is connected in parallel with a second resistor and a second diode,
wherein the first circuit block and the second circuit block are connected in series.

5. The device of claim 4, wherein the capacitor of the first circuit block blocks the DC component of the ring signal.

6. The device of claim 4, wherein the diode of the first circuit block allows a current loop to be established from the first tip line to the first ring line.

7. The device of claim 6, wherein the current loop from the first tip line to the first ring line is established when the client telephony device is on-hook.

8. The device of claim 6, wherein the current loop from the first tip line to the first ring line is established when the client telephony device is off-hook.

9. The device of claim 4, wherein the diode of the second circuit block rectifies the tip signal of the first tip line.

10. The device of claim 4, wherein the capacitor includes a first polarized capacitor connected in series with a second polarized capacitor.

11. The device of claim 10, wherein a polarity of the first polarized capacitor is opposite a polarity of the second polarized capacitor.

12. The device of claim 2, wherein the ring signal and the tip signal are identical signals with a 180-degree phase shift during ringing state.

13. The device of claim 1, wherein the client telephony device includes at least one of a telephone, a fax machine, and an answering machine.

14. The device of claim 1, wherein the source includes a subscriber line interface circuit.

15. The device of claim 14, wherein the subscriber line interface circuit resides within a node of a passive optical network.

16. The device of claim 14, wherein the subscriber line interface circuit resides within a central office of a telephone service provider.

17. The device of claim 14, wherein the subscriber line interface circuit resides within a private branch exchange system.

18. The device of claim 1, wherein the offset voltage is approximately −50 volts.

19. A method comprising:
receiving a ring signal on a ring line;
shifting the ring signal by an offset voltage; and
providing the shifted ring signal to a client telephony device.

20. The method of claim 19, further comprising receiving a tip signal on a tip line.

21. The method of claim 20, further comprising:
rectifying the tip signal; and
superimposing the rectified tip signal onto the ring signal to shift the ring signal by an offset voltage.

22. The method of claim 20, wherein the ring signal and the tip signal are identical signals with a 180-degree phase shift during ringing state.

23. The method of claim 20, wherein the ring signal and the tip signal are sinusoid waves.

24. The method of claim 20, wherein the ring signal and the tip signal are one of square waves, triangle waves, and trapezoid waves.

25. The method of claim 20, further comprising establishing a current loop from the tip line to the ring line when the client telephony device is on-hook.

26. The method of claim 20, further comprising establishing a current loop from the tip line to the ring line when the client telephony device is off-hook.

27. The method of claim 19, wherein the client telephony device includes at least one of a telephone, an answering machine, and a fax machine.

28. The method of claim 19, wherein shifting the ring signal by an offset voltage includes shifting the ring signal by approximately −50 volts.

29. A telephony device comprising:
means for receiving a ring signal from a source;
means for shifting the ring signal from the source by an offset voltage; and
means for outputting the shifted ring signal to a client telephony device.

30. The device of claim 29, further comprising:
means for receiving a tip signal from the source; and
means for outputting the tip signal to the client telephony device.

31. The device of claim 30, wherein the means for shifting the ring signal by an offset voltage includes:
means from rectifying the tip signal; and
means for superimposing the rectified tip signal onto the ring signal to shift the ring signal by an offset voltage.

32. The device of claim 29, wherein the shifting means shifts the ring signal by approximately −50 volts.

33. A telephony system comprising:
a source that generates a ring signal and a tip signal;
a ring signal shifter that electrically couples to the source via a first ring line and a first tip line; and
a client telephony device the electrically couples to the ring signal shifter via a second ring line and a second tip line;
wherein the ring signal shifter receives the ring signal from the source via the first ring line, shifts the ring signal from the source by an offset voltage, and outputs the shifted ring signal the client telephony device via the second ring line.

34. The system of claim 33, wherein the ring signal shifter further receives the tip signal from the source via the first tip line and outputs the tip signal to the client telephony device via the second ring ling.

35. The system of claim 34, wherein the ring signal shifter includes a voltage shift circuit that rectifies the tip signal from the source and superimposes the rectified tip signal onto the ring signal to shift the ring signal by an offset voltage.

36. The system of claim 33, wherein the client telephony device includes at least one of a telephone, a fax machine, and an answering machine.

37. The system of claim 33, wherein the source includes a subscriber line interface circuit.

38. The system of claim 37, wherein the subscriber line interface circuit resides within a node of a passive optical network.

39. The system of claim 37, wherein the subscriber line interface circuit resides within a central office of a telephone service provider.
